(19) United States
(12) Patent Application Publication
(10) Pub. No.: US 2004/0133571 A1
(43) Pub. Date: Jul. 8, 2004

(54) Adaptive item search and user ranking system and method

(76) Inventors: Martin Horne, Richmond (CA); Graeme D. Johnson, Ottawa (CA); Frank M. Jones, Carp (CA)

Correspondence Address: JENKENS & GILCHRIST, P.C., 225 WEST WASHINGTON, SUITE 2600, CHICAGO, IL, 60606, US

(21) Appl. No.: 10/741,021

(22) Filed: Dec. 19, 2003

Related U.S. Application Data
(60) Provisional application No. 60/435,330, filed on Dec. 20, 2002.

(51) Int. Cl. G06F 17/30

(52) U.S. Cl. 707/3

(57) ABSTRACT

An application program is employed in a computer network of users to locate items and rank users who supervise, manage, or otherwise control these items based on associations between users, items, and user preferences. The present invention software executed in this network provides user recommendations to enable, streamline and enhance human-to-human communications and associated business transactions.

### CROSS-REFERENCE TO RELATED APPLICATION

This application claims the benefit of U.S. Provisional Patent Application Serial No. 60/435,330, filed Dec. 20, 2002 and entitled “Adaptive Item Search and User Ranking System and Method,” which is incorporated herein by reference in its entirety.

### FIELD OF THE INVENTION

The present invention is generally directed to systems and methods for facilitating communications and commerce. More particularly, the present invention is directed to systems and methods employed in a computer network of users to locate items and rank users who supervise, manage, or otherwise control these items based on associations between users, items, and user preferences.

### BACKGROUND OF THE INVENTION

Electronic commerce systems have been developed to improve business efficiency through automating and streamlining business-to-business (B2B) and business-to-consumer (B2C) transactions.

Businesses are connected through integrating their client-server based enterprise systems (for example, enterprise resource planning (ERP) and supply chain management (SCM)) using traditional electronic data interchange (EDI) technologies or through Enterprise Application Integration (EAI) tools or more recently through web services. Connections created by these technologies can improve well-understood fixed transactions that would otherwise be labor intensive. But they fail to address less-understood transactions and more complex human-to-human interactions.

Portals are used both between businesses and from businesses to consumers to connect users with businesses (e.g. an electronic purchasing system). Portals have also been used as a centralized meeting point for users to facilitate trade (e.g. a public auctioning system) or to facilitate human-to-human communication (e.g. an email directory service). A portal can provide a useful directory service, but these services suffer from a number of drawbacks. In particular, directories are difficult to maintain, are inappropriate or ineffective in storing user data and preferences, and are generally quite static, not reflecting real-time changes.

Despite advances made in automated e-commerce, direct human-to-human communication remains a pervasive and necessary activity in collaborating, monitoring, negotiating, and trading of items such as goods or services. However, facilitating direct human-to-human communication and transactions poses a significant technological hurdle. The great majority of these activities are assisted exclusively by the phone, fax and email.

Distributed peer-to-peer (P2P) technologies have recently been developed and applied primarily in the areas of file sharing, instant messaging, collaboration, and distributed processing and storage. Client-server systems are still currently the mainstay of enterprise applications, but P2P technology is emerging as an important model on which to base novel systems to support business processes. In particular, this technology is well suited to complementing and enhancing activities that involve human-to-human interactions.

P2P technologies excel in a number of important areas. The computing infrastructure needed to support application deployment is already in place with standard Internet-connected desktop computers. Real-time human-to-human interactions are readily supported; examples of this are instant messaging and collaboration. Data can be directly published from and subscribed to from standard desktop computers. Finally, with peer-to-peer technologies human-to-human relationships can be quickly enabled allowing self-forming and adaptive networks to emerge.

As P2P networks emerge to become a critical element of business processes a new problem arises. How do individual users identify and locate items, and contact and collaborate with the most appropriate person in a network who can meet their particular needs?

Current systems largely rely on past relationships between collaborating parties. They assume you know the party with whom you wish to communicate. This may be fine when the network is only used to enhance an existing relationship, like a son communicating with his mother via instant messaging. However, past relationships are not always enough when a network consists of hundreds or thousands of participants that can address a specific problem for a user. For example, a buyer with very limited time and a specific budget may have difficulty sourcing a critical part from many possible suppliers. In this case the buyer benefits greatly from knowing who is immediately available to quickly address his critical supply problem within the constraints the buyer imposes, the fastest.

One method that attempts to provide appropriate item recommendation is content-based filtering. The content-based filter selects items from a domain for the user to review based upon correlations between the content of the item and the user's preferences. There are several drawbacks to this approach. First, content might not be available on-line in a format that is conducive to analysis. Second, and more importantly, this approach does not take into account the likelihood of consummating a business relationship related to the item that is being located. For example, the likelihood of trading a part is based on many other factors like the on-line availability or presence of a user who controls the part, the number of past transactions a user has performed, item availability, and delivery capabilities. Content-based filtering item recommendations are therefore not ideal for facilitating the trading of items, be they goods or services.

Another method employed to recommend items is based on user input rankings and profile matching. This technique recommends items to users based on rankings of items by other similar users. Similar users are determined based on correlating rankings of similar items between users. This approach is helpful in recommending a movie, by matching one user's movie rankings with another and deriving movie recommendations based on these similarities. However, this approach does not apply to users who are seeking a good or service on-line from another individual.

Finally, another method is employed to recommend users with certain expertise to users seeking this expertise based on a user's authorship and document usage. The system analyses the documents a user has authored or accessed and derives a person's expertise from this analysis. While this approach is helpful in generating a knowledge network, it fails to provide fundamental elements that assist in enabling and enhancing productive human-to-human business transactions. These important missing elements include the user's availability or presence, item availability, quantity, price, past transactions, and user preferences.

### SUMMARY OF THE INVENTION

The need for users to quickly identify and locate items (goods or services) given certain constraints, and to contact and collaborate with the most appropriate person in a network who can meet their particular needs, creates an environment that can be addressed by an adaptive item search and user ranking system enabled by a peer-based architecture.

The present invention helps individuals quickly determine the most appropriate users available in a network to address their particular needs. Systems and methods according to the present invention present ordered or ranked lists of users who supervise, manage or otherwise control particular goods or services. Ordering of the user list may be based on a combination of published item attribute data, historical transaction data, user profile data, and request history. Current systems assume a user already knows the party with whom they will conduct business, and it is difficult to trust and connect to an unknown party. The present invention recommends the most appropriate users who control items that are of interest to the requesting user, whether or not a past relationship exists between the parties.

According to one embodiment of the present invention, a system consists of two major components. A user package manages the peer node on a user's desktop computer. This package contains private user profile information, private transaction data, an item request forwarder, an incoming item request manager, and an item data publisher. A router package accepts item search requests and either returns a list of user recommendations for the associated item or routes search requests directly to user packages. A recommendation engine analyzes past transactions, request criteria and user assigned weightings, user profiles, and indexed item data to provide the appropriate user recommendations.

User recommendations are derived by the recommendation engine based on such parameters as availability or presence of a user, item availability, item quantity, user satisfaction rankings, number of past transactions by the user, delivery terms, request criteria and user-defined weightings, and/or other criteria.

Preferably, the messaging language used is XML (extensible markup language). This markup language is being used for a wide variety of applications. Its extensibility, structure, and ability to be validated give it significant advantages over other approaches. The widespread use of XML in business systems also makes it attractive by allowing the invention to interoperate with other systems. Other messaging languages and data structures may be used.

Preferably, the messaging transport layer used is HTTP (hyper text transfer protocol) or SOAP (simple open access protocol). Other transport layers and protocols may be used.

One embodiment of the invention identifies appropriate users and trading goods in a distributed goods trading system. Another embodiment of the invention locates specific expertise or services in a distributed network of users. Both of these embodiments may facilitate interactions between independent users, between users within enterprises, and between users in different enterprises using local, wide area, Intranet, Internet, or other networks. In some cases these embodiments of the invention are used in conjunction with other enterprise systems like an Enterprise Resource Planning (ERP) system, and may be closely associated with collaboration technologies such as instant messaging, and other communication technology such as email.

### BRIEF DESCRIPTION OF THE DRAWINGS

FIG. 1 is a block diagram showing system components according to one embodiment of the present invention;

FIG. 2 is a block diagram showing components found inside one embodiment of a user package;

FIG. 3 is a block diagram showing components found inside a one embodiment of a router package;

FIG. 4 is a schematic showing functions of a user package;

FIG. 5 is a flow chart showing the process of making a search recommendation request from within a user package according to one embodiment of the present invention;

FIG. 6 is a flow chart showing the procedure for processing a response to a search request from within a user package according to one embodiment of the present invention;

FIG. 7 is a flow chart showing the method for processing a search request from within a user package according to one embodiment of the present invention;

FIG. 8 is a flow chart showing how an item index is created and uploaded from a user package to a router package according to one embodiment of the present invention;

FIG. is a schematic diagram showing the features of a profile management portion of a user package according to one embodiment of the present is invention;

FIG. 10 is a schematic that lists the main features of a router package and shows details of the processing of several router package elements according to one embodiment of the present invention.

FIG. 11 shows the method for recommending target users for a search request according to one embodiment of the present invention;

FIG. 12 illustrates an embodiment of the invention as it applies to inventory visibility, locating, and trading in a network of users;

FIG. 13 illustrates an embodiment of the invention as it applies to expertise or service visibility and locating in a network of users; and

FIG. 14 illustrates an embodiment of the invention as it applies to expertise or service visibility and locating in a network of users.

While the invention is susceptible to various modifications and alternative forms, specific embodiments are shown by way of example in the drawings and will be described in detail herein. However, it should be understood that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE ILLUSTRATED EMBODIMENT

The present invention is an event-based system that is distributed throughout a network at various nodes. According to one embodiment of the invention, there are two main node types: user packages, and router packages. Events within this system may be either system-generated or user-generated. An event may be closely coupled within a particular node and may directly trigger a feature of the system, or events may be transmitted in the form of messages that are directed to a particular node, or group of nodes. According to some embodiments of the present invention, events may take the form of messages to trigger features of the system.

The network the invention operates in may be a local area network (LAN), a wide-area network (WAN), the Internet, or other computer network types. The system may operate to support locating items and ranking users between independent individual users, users within a single enterprise who may operate within a corporate Intranet, or between users within multiple enterprises where their Intranets are connected either by the Internet or through other direct connection types like EDI.

Various message types may be sent between users of the system, between users and routers within the system, and between routers. According to one embodiment of the invention, there are four main message types that directly support search recommendations and requests. They are: a) search recommendation request—a request the user makes for a recommendation of users who control items of interest based upon the requesting user's criteria, b) search request—a request the user makes to an individual user or group of users for information on items of interest to the requesting user based upon the requesting user's criteria, c) search recommendation request reply—a response to the search recommendation request message that contains recommendations, and d) search request response—a message that is sent in response to a search request message with details on the requested item information. In addition, there are several other utility message types that are described in detail later in this description.

Search recommendation requests and search requests may contain a target list. The target list is used to help specify which users should receive a given request message.

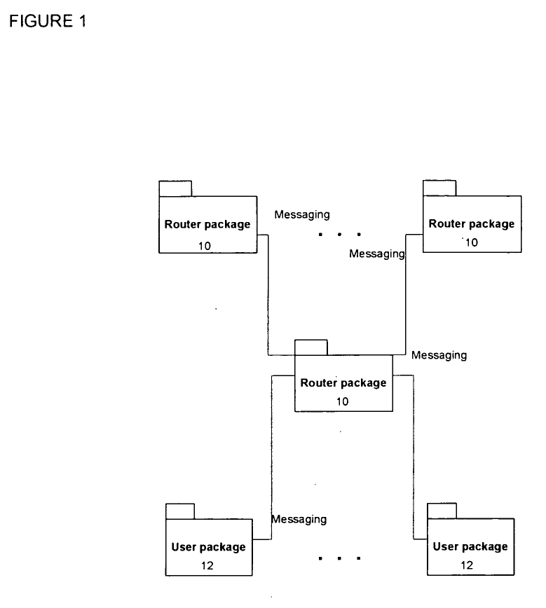

FIG. 1 identifies the two main components provided by a user ranking system according to one embodiment of the present invention: a router package 10 and a user package 12. Communication connections are made between these packages using HTTP, SOAP or other messaging and message transport protocols. Messages may travel over these connections using one or more of a variety of paths, such as: from one user package to another, from one router package to another, and between user and router packages. Messages are preferably represented using XML. Other types of message representation may be used, depending on requirements of particular implementations of the present invention. For example, messages may be represented using EDI formats.

According to one embodiment of the present invention, a network topology consists of multiple user packages that connect to a single router package. Router packages may communicate with one or more other router packages. This topology allows for varying degrees of search across the system. Searches may be performed within the scope of a single user package, a single router package, or across multiple user packages and router packages.

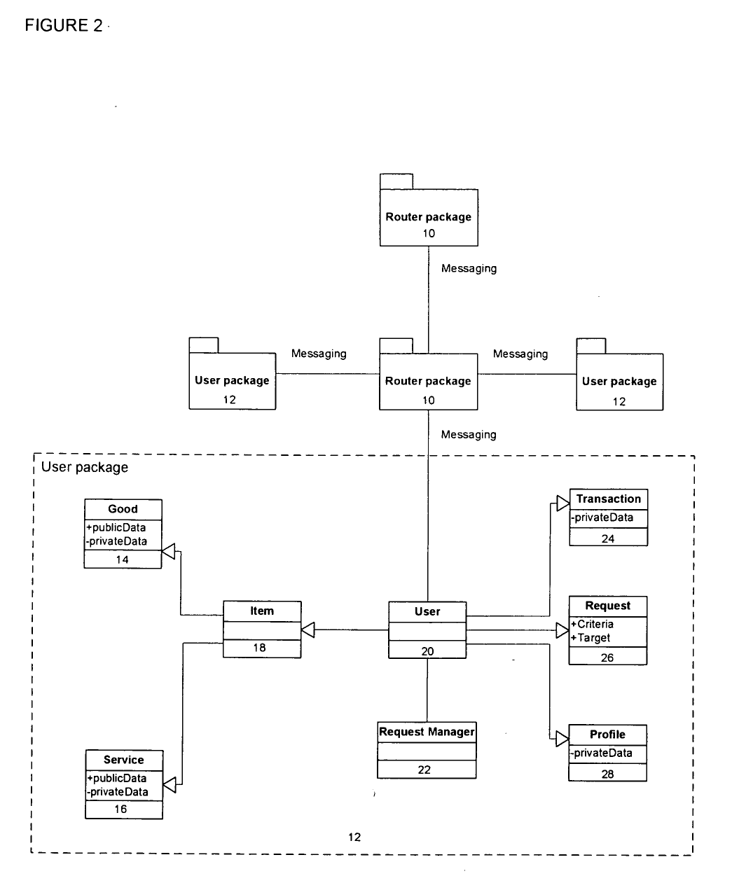

FIG. 2 shows the major components of a user package 12. Preferably, user packages are executed on computers that are accessed directly by a user. For example, Internet-connected desktop computers or handheld devices may be used to access and interact with a user package. The user package is used by the system to: publish item data to the network, respond to search requests, perform search requests, present results from search requests, record private transaction data, record private request data, and store private user profile data.

Item data 18 consists of information describing a good 14 or service 16 that is supervised, managed, or otherwise controlled by a user. The user package 12 may publish this data or otherwise make this data available to allow other network users to search and retrieve information on items or to subscribe to receive event notifications when certain conditions are met. For example, when data on a particular item highlighted as important to the user is updated, the user may be provided with information on this update. The user package 12 may segregate item data 18 into private data and public data. According to some embodiments of the invention, the registered user of a user package may only access private data. Further, in some embodiments, public data may be accessed by other user packages or routers subject to certain authentication and access control provisions. According to some embodiments of the present invention, item data 18 is monitored by the user package 12. The user package 12 may respond to a decrease in a quantity of an item by generating an event that is sent to other user packages subscribed to that item data. Subscriptions and corresponding conditions are stored within user profile data for the subscribing user. For example, these embodiments may enable a user package to generate a search recommendation request when a user's inventory of a particular item drops below a threshold level.

The user package 12 may respond to search requests using a request manager 22. The request manager 22 analyzes the details of the request and searches the local item data for matches to the request. A list of matches is returned to the requesting package.

Search requests may be initiated within a user package through specifying the request criteria and the target of the request. Request criteria are specified directly by the user. Individual criteria may be combined to provide a composite criteria value. Criteria may be combined in a composite manner using various techniques, including an interface that develops Boolean expressions like: (MUST HAVE—Attribute A) AND ((PREFER—Attribute B) OR PREFER Attribute C)). Other expression formats may be used, for example constraint-based expressions or linear programming techniques. Request targets may be assisted by the recommendation engine 36 in the router, may be directly specified, or may be broadcast to all available user packages.

According to one embodiment of the present invention, search results are presented to the user within a user package. Results can be comprised of one or multiple incoming messages. The user package compiles ranked search data with other search responses to form a personalized ranked list of items searched for and their associated data. According to some embodiments of the present invention, the personalization of search results considers recommended rankings and personal preferences stored in the profile data 28 of a user package.

A transaction data log 24 is employed to store certain transactions generated by messages within the system or from other systems. The transaction data log 24 is segregated into a public transaction data log and a private transaction data log. According to one embodiment of the present invention, public transaction data is stored in the transaction log 24 in a router package 10, and private transaction data is stored in the transaction log 24 in a user package 12. The public transaction log may be one of the elements processed within a router package to determine recommendations. Examples of transaction data include information on the parties and goods or services involved in transactions, transaction dates and times, the volume of goods or the extent of the services involved in transactions, transaction turnaround time, transaction budget information including information on whether a budget was met or exceeded, and transaction costs. Some or all of these and other transaction-related information may be stored in the transaction data log 24.

A request data log 26 is employed to store requests generated from within a user package 12. The request data log 26 is segregated into a public request data log and a private request data log. Public request data is stored in the request log 26 in a router package 10. Private request data is stored in the request log 26 in a user package 12. The public request log may be one of the elements processed within a router package 10 to determine recommendations. Examples of request data include information on the parties making the requests, request dates, whether the request resulted in an acceptable match or resolution to the request, and request contents. Some or all of these and other request-related information may be stored in the request data log 26.

User profile data 28 contains information such as account information, network connections, security settings and keys, personal search list settings, search criteria, and list appearance information. User profile data may be segregated into a public user profile section and a private user profile section. Public profile data may be stored in the profile section of a router package 10. Private profile data may be stored in the profile section of a user package 12. The public profile section may be one of the elements processed within the router to determine recommendations. Typical examples of public profile data include a user's contact information and in some cases user's presence information (on-line, away, busy etc.).

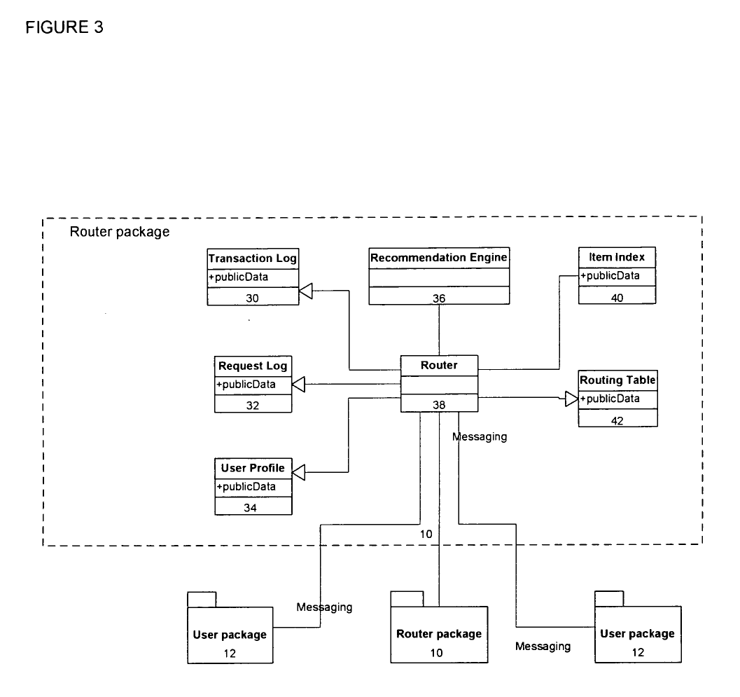

FIG. 3 shows the major components of one embodiment of a router package. Preferably, router packages are executed on computers with high availability and good storage, bandwidth, and latency characteristics. A router package is preferably executed on computers having adequate storage capacity to contain all necessary logs, indexes and tables, bandwidth allowing data transmission rates that do not limit a user's productivity, and latency characteristics allowing for request processing and forwarding within timeframes that are acceptable to users. Internet-connected server computers may be used to execute router packages according to one embodiment of the present invention. Router packages may alternatively be executed on any other network-connected computers. According to one embodiment of the present invention, router packages serve as the central request processing and resolution component of the system. Depending on specific implementations of the present invention, a router package may be is used to perform one or more of the following functions: index item data, record public transaction data, record public request data, store public user profile data, respond to search recommendation requests, and route search requests.

Item index data 40 may be stored in a router package to help speed up searches performed within the system and to improve recommendations provided by the recommendation engine. Item index data may be periodically uploaded from user packages to one or more associated router packages. When requested to do so by the appropriate search recommendation request, the recommendation engine may process the item index to determine item matches.

Public transaction data 30 may be stored in a router package to store certain transactions generated by messages within the system or from other systems. Public transaction data 30 may be stored in the transaction log in a router package 10. The public transaction log may be one of the elements processed within a router package to determine recommendations.

Public request data 32 may be stored in a router package to store requests generated by a user package. Public request data 32 may be stored in the request log in a router package. The public request log may be one of the elements processed within a router package to determine recommendations.

Public user profile data 34 may also be stored in a router package. Public user profile data 34 may be one of the elements processed within a router package to determine recommendations.

Search recommendation requests may be received by a router package directly from user packages or indirectly from user packages via other router packages. In this case, the router package takes the criteria specified in the search recommendation request and the target list to determine search recommendations. A recommendation engine 36 performs these recommendations.

During a search recommendation request, the target list may be used by a router package to determine the breadth of the search. Searches may be confined to the local router package, to the local router package and its associated user packages, to connected router packages, or to user packages associated with the connected router packages. Searches that go beyond the initial router package are routed to the other system elements using a routing table 42. The system topology is structured to ensure that search recommendation requests routed and propagated throughout the system (i.e. to other router packages and user packages) are not redundant and remain efficient.

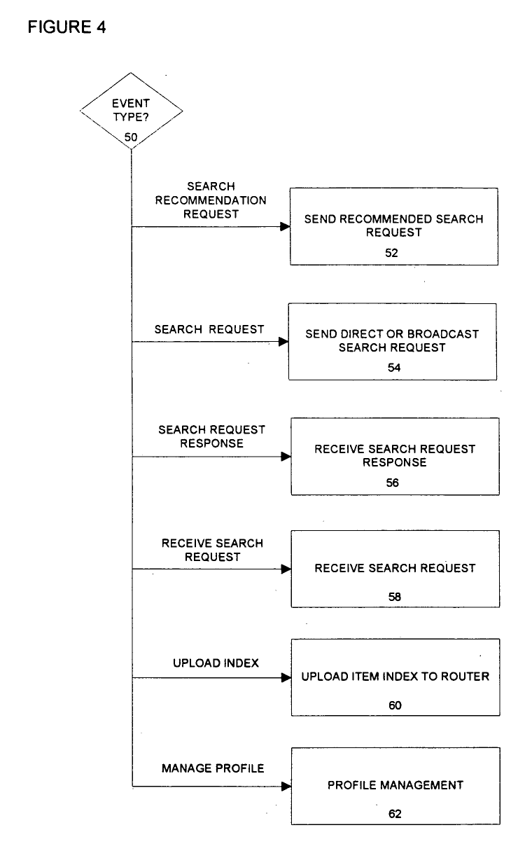

Turning now to FIG. 4, a schematic is shown listing the main features of a user package according to one embodiment of the present invention. These features may be triggered by an event either through a user interaction with the system or through a message being received by a user package. Step 50 is the entry point for a user package. At this step the feature type is determined based on an incoming event and flow is transferred to the corresponding module.

The search recommendation request process 52 is used to obtain a search recommendation from the recommendation engine 36 and to either return that recommendation to the requesting user package or to forward a search request to the recommended users.

The search request process 54 is used to send a search request directly to specified user packages or broadcast a search request to all user packages.

The search request response process 56 is used to process incoming responses to a search recommendation request or search request initiated from the source user package.

The receive search request process 58 is used to process incoming search requests from other user packages (direct or indirect). This process replies with search results acquired from the local user package by analyzing local item data.

The upload index process 60 is used to upload item index data from a user package to the associated router package. The user may enter item index data into a user package, or it may reflect the results of an automatic item index updating system from such systems as an inventory control system, an enterprise resource planning (ERP) system, or other enterprise systems. This item index data may then be stored in the item index in a router package to enhance search recommendations. According to one embodiment of the present invention, only public item data is indexed and stored in a router package.

The manage profile process 62 is used to allow users to manage all elements of their profiles including such elements as account information, network connections, security settings and keys, personal search list settings, search criteria, and list appearance information.

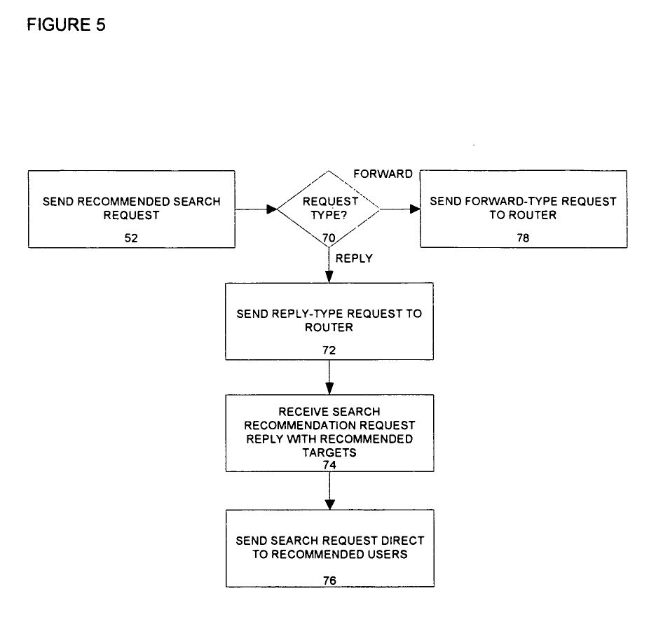

Turning now to FIG. 5, a flow chart illustrates the steps carried out within a user package to process a search recommendation request according to one embodiment of the present invention. The search recommendation request process 52 of a user package formats a search recommendation request message that is sent to a router package. In the embodiment shown in FIG. 5, there are two basic forms of search recommendation requests: a reply-type request, and a forward-type request. Step 70 determines the request type. If the request is of forward-type then the forward-type request is sent to a router package as shown at block 78. If the request is of reply-type then the reply-type request is sent to a router package as shown at block 72. A user package then receives the reply from the router in step 74. Following this a user package sends a search request directly to the recommended users as shown at block 76.

A reply-type request asks a router package to respond with a message from a router package to a user package. This return message contains a router package's recommendations. The forward-type request asks a router package to forward a search request to the recommended user packages. In this case messages may be sent back directly from these user packages to the requesting user package. Alternatively, reply messages may be sent from request-receiving user packages to one or more router packages, and from router packages back to the requesting user package.

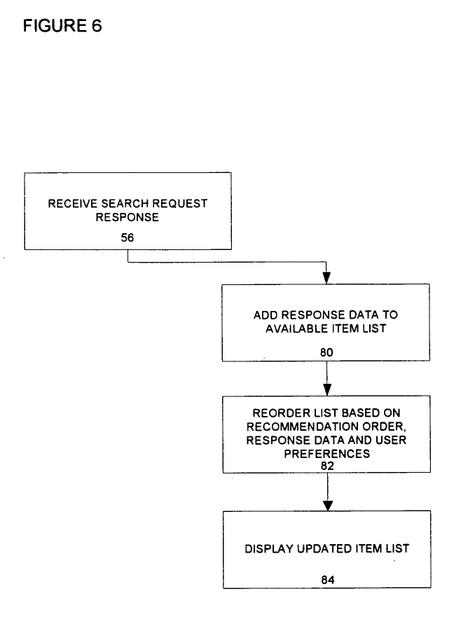

Turning now to FIG. 6, a flow chart shows the process followed by a user package receiving a search request response according to one embodiment of the present invention. Search request responses may be delivered as search request response messages. Search request response messages are received by a user package, as shown at block 56, in response to a search request, originally sent either directly as shown at block 54 or through a search recommendation request as shown at block 52 of FIG. 4. Upon receipt of the search request response message, a user package adds item response data, containing information on the items involved in the search request, to an available item list in step 80. This list contains all responses to a particular search request. Items in the list are then ordered based on recommendations, the original search criteria, and user preferences in step 82. The user-displayed list is then updated in step 84.,

For example, the user may have requested service provider recommendations for a particular service and then sent messages to those service providers requesting more detailed item data (i.e., data describing attributes of their particular service). Individual search request response messages will be received from each of the responding service providers containing the attributes of their service. A user package orders these responses in the available item list based on the original recommendations received, the original request criteria, and user preferences. Preferences can contain certain user overrides and list cutoff requirements. A system or method following a user override or list cutoff requirement may only present the five highest-ranked users, or never present users on the personal “ignore” list.

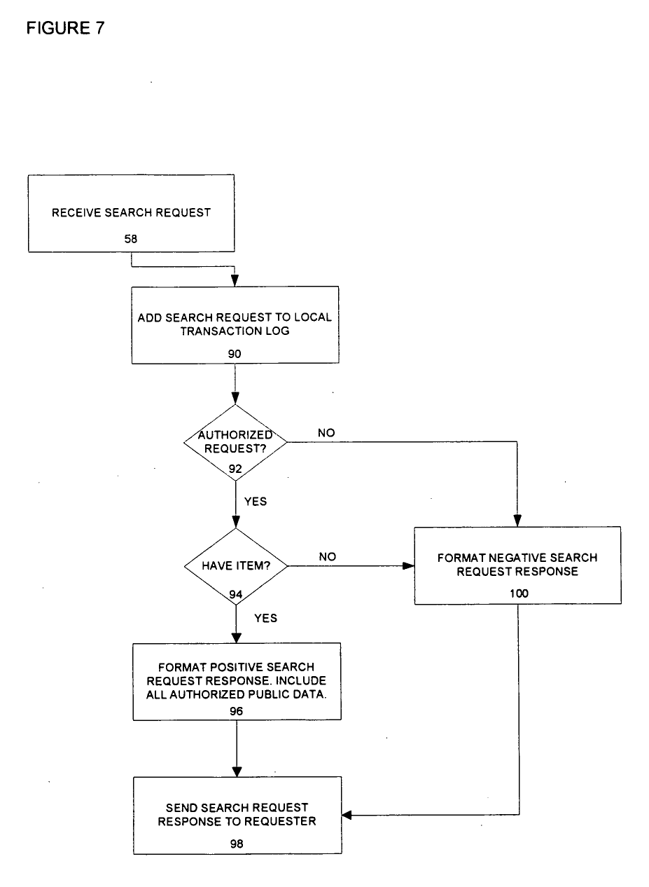

Turning now to FIG. 7, a flowchart is shown illustrating the process initiated when a user package receives a search request according to one embodiment of the present invention. Search request messages are received by a user package from other requesting user packages, either directly, or routed through router packages, as shown at block 58. Upon receipt of a search request message, a user package adds the search request to its local transaction log, as shown at block 90. It then determines if the requesting party is identified correctly, is authentic, and is granted access to a user package for making the specified request in step 92. If the requesting party fails this test, a negative search response request is formatted in step 100.

Otherwise, if the request is authorized, a user package determines if the item being requested is supervised, managed or otherwise controlled by the request-receiving user by checking the local item data store 18, as shown at block 94. If the requested item is not published or otherwise indicated by a user package as under the control of the request-receiving user, a negative search request response is formatted in step 100. Otherwise, a positive response is formatted in step 96 that includes all authorized available public data associated with the item. According to one embodiment, private data is never sent outside a user package. Access control may be conditionally granted to certain elements of public item data. For example, certain users may be granted access to cost information of a particular good or service, while others are not is granted access to this. Further, according to some embodiments of the present invention, a user may allow certain private information to be accessible outside a user package. This access may be extended only to familiar users.

Finally, a user package sends the formatted request response packet to the requesting party in step 98.

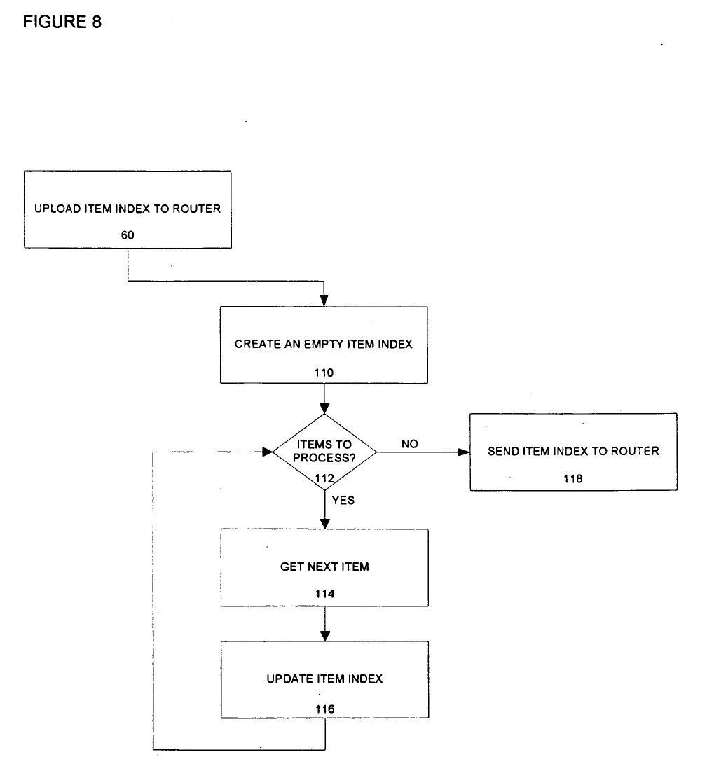

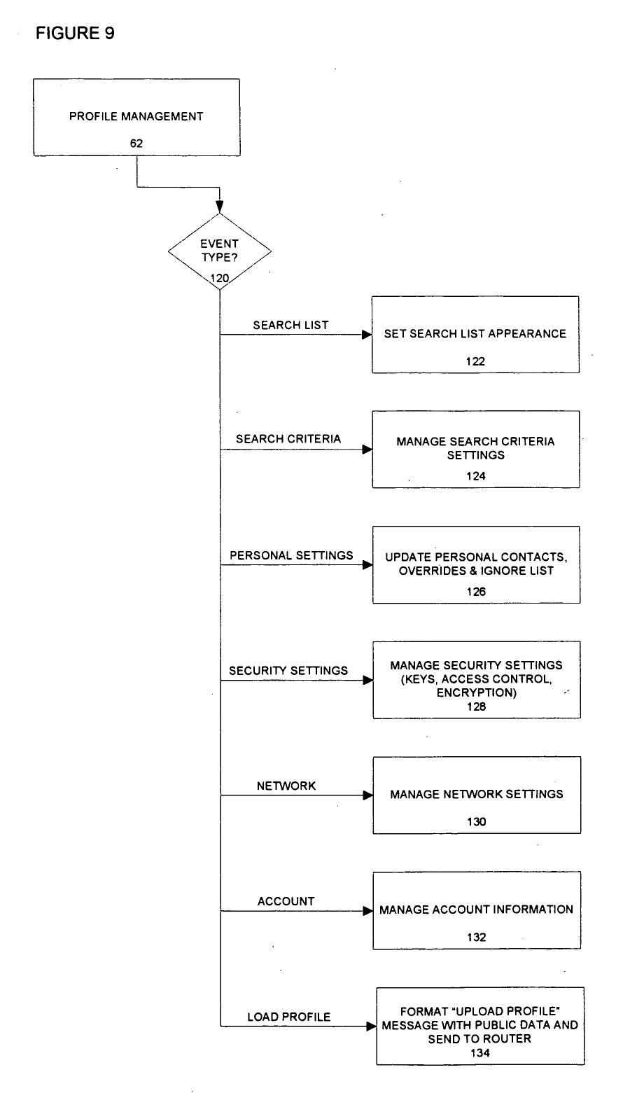

According to some embodiments of the present invention, in order to improve both search performance and recommendations, the system periodically uploads item index data from user packages to router packages. FIG. 8 is a flowchart showing the process of uploading item index data from a user package to a router package. When triggered in step 60, this process updates the item local index to reflect the current state of item data in a user package. The process is a looping technique shown at blocks 110, 112, 114, and 116. First, an empty item index is created in block 110. Next, a decision is made in block 112, determining if there are still items to process. If so, the next item is retrieved in step 114 and the item index is updated in step 116. Control is then transferred back to decision block 112. Once the item index is completely developed and there are no more items to process, block 112 transfers control to block 118 where a load item index message is formatted and sent to a router package.

Profiles may be used within systems according to some embodiments of the present invention to facilitate searches, increase search relevance, and enhance user-system interfaces. FIG. 9 shows processes involved in profile management. Profile management features allow the user of a user package to update and manage settings for: search list, search criteria, personal contacts, overrides, security certificates, security keys, access control, encryption, network settings, and/or account information. This process also allows for public profile information to be uploaded to a router package to improve system search performance and recommendations. Once this process is triggered as shown at block 62, the type of profile management activity is selected as shown at decision block 120. These features are selected through examining the input event that is provided either through a user interaction with the system or through a message being received by a user package. For example, this selection could be performed through a user menu with these choices or through other programmatic means.

The search list feature, shown at block 122, is used to set user preferences for the appearance of the search list. This includes the list viewing area size and position, fonts, highlighting techniques and other visual features.

The search criteria feature, shown at block 124, is used to identify search attributes and to assign user-supplied weightings to the search attributes. These attributes and weightings are used by a router package to derive the most appropriate recommendations and user rankings. They are also used by a user package upon receipt of search results to order and filter search results. One embodiment of the search criteria feature assigns slider bars to each attribute. The user adjusts the position of the slider bar to adjust the weighting of the associated attribute. Another embodiment assigns discrete values to attributes such as: MUST HAVE or PREFER. The search criteria feature includes the ability to form Boolean expressions and other multi-variable combination techniques to combine the weighting of available attributes that are applied by a router package when deriving recommendations and by a user package when ordering and filtering search results.

The personal settings feature in step 126 allows the user to maintain a personal contact list. Additionally, users may specify personal search overrides. Overrides can specify the search list length and force specified attributes to a given position in the search list. One example of an override would force a particular user to the top of a list whenever the particular user is identified on a list. Finally, users may also maintain an ignore list of users that they do not wish to search or to appear in their search lists.

The security settings feature in step 128 allows the user to: generate public and private encryption key pairs for encryption and digital signatures, update their access control list to govern access of specific item data to specified users, and to define the encryption techniques that are used—for example, Public Key Infrastructure (PKI), and/or Secure Sockets Layer (SSL).

The network feature, shown at block 130, is used to identify network connection information. Specifically, the network feature may be used to identify router package elements, locations, and connection types, message formats, and protocols.

The account feature, shown at block 132, is used to update a user's account information such as: username, password, contact information, displayed user name, and presence preferences, for example, whether or not to make the users' presence information public.

The load-profile feature shown at block 134 is triggered by the user or by a requesting router package to upload public user profile information into a router package. A user package formats a message containing all public user profile information and sends this message to a router package.

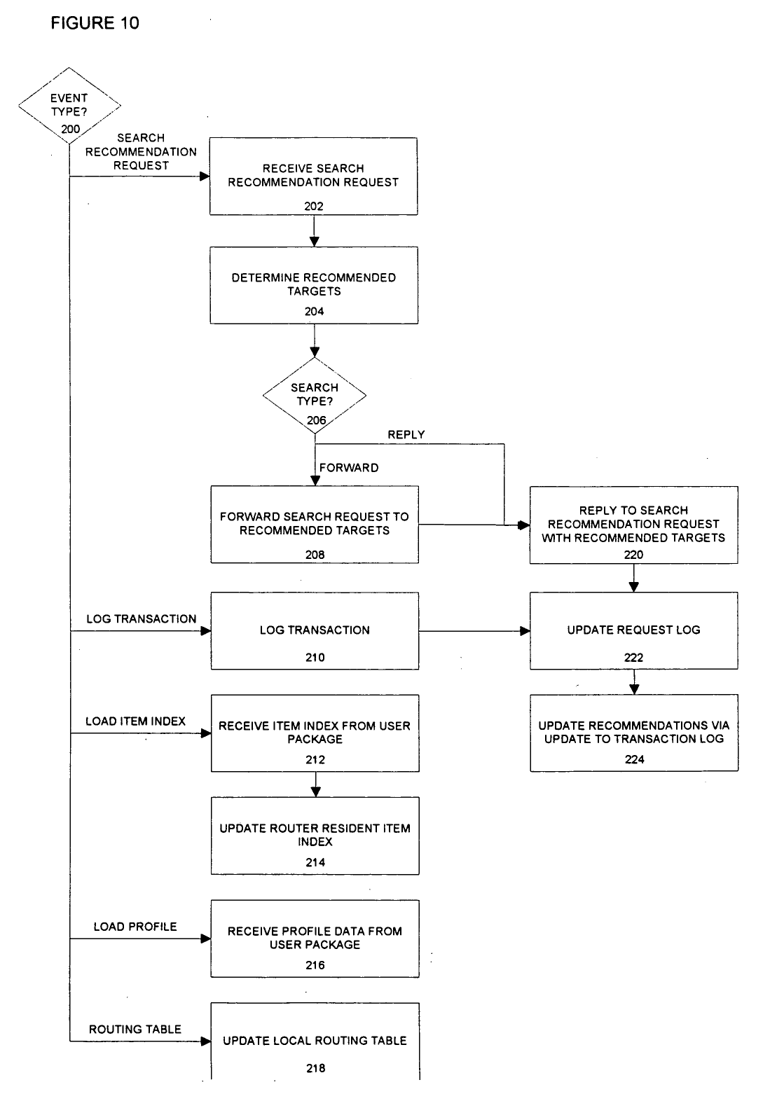

FIG. 10 is a schematic that lists the major features of a router package according to one embodiment of the present invention and provides details for a number of its associated processes. According to one embodiment of the present invention, a router package is used to: recommend users, log requested transactions, maintain item indexes, maintain public user profile information, and route search messages. The router package is triggered upon receipt of an incoming message. Upon receipt of an incoming message, the message event type is determined as shown at decision block 200 and the appropriate process is dispatched.

On receipt of a search recommendation request message at block 202, a router package determines recommended targets (users with associated item data) using its recommendation engine 36. The recommended targets are determined at block 204. After this, a router package determines which request type is received at block 206. For reply-type requests, a router package replies with the recommended targets at block 220, updates its request log to record the request as shown at block 222, and updates the transaction log at block 224 with any new recommendation information that is derived from responding to the request.

For example, recommendation information derived from responding to the request may include information on new possible targets for specific types of requests, or information on which recommendations are most useful for certain requests. This allows the system to learn from past transactions to improve future target recommendations. For forward-type requests, a router package first forwards search requests to the recommended targets at block 206, before proceeding to block 220.

The log transaction process is triggered at block 210 by a requesting party sending a router package a log transaction message. The system stores the transaction request as shown at block 222 and proceeds to store the content of the message in the transaction log for future auditing, and recommendation purposes, as shown at block 224. Information in the transaction log may be used by a router package when replying to future requests.

The load item index process receives a load item index message at block 212 from a user package. This message contains indexed public item data that is stored in a router package's item storage area. Item index data is used to speed item searching and enhance recommendations provided by a router package. The item index is updated at block 214.

The load profile process is used by a router package to load public profile information from a user package. The message contents are loaded in the user profile data 34 as shown at block 216.

The routing table process is triggered within a router package upon receipt of the routing table message at block 218. This message contains updated routing table information to allow the local router package to locate and route messages to other router packages. The message contents are loaded in the routing table 42 as shown at block 218.

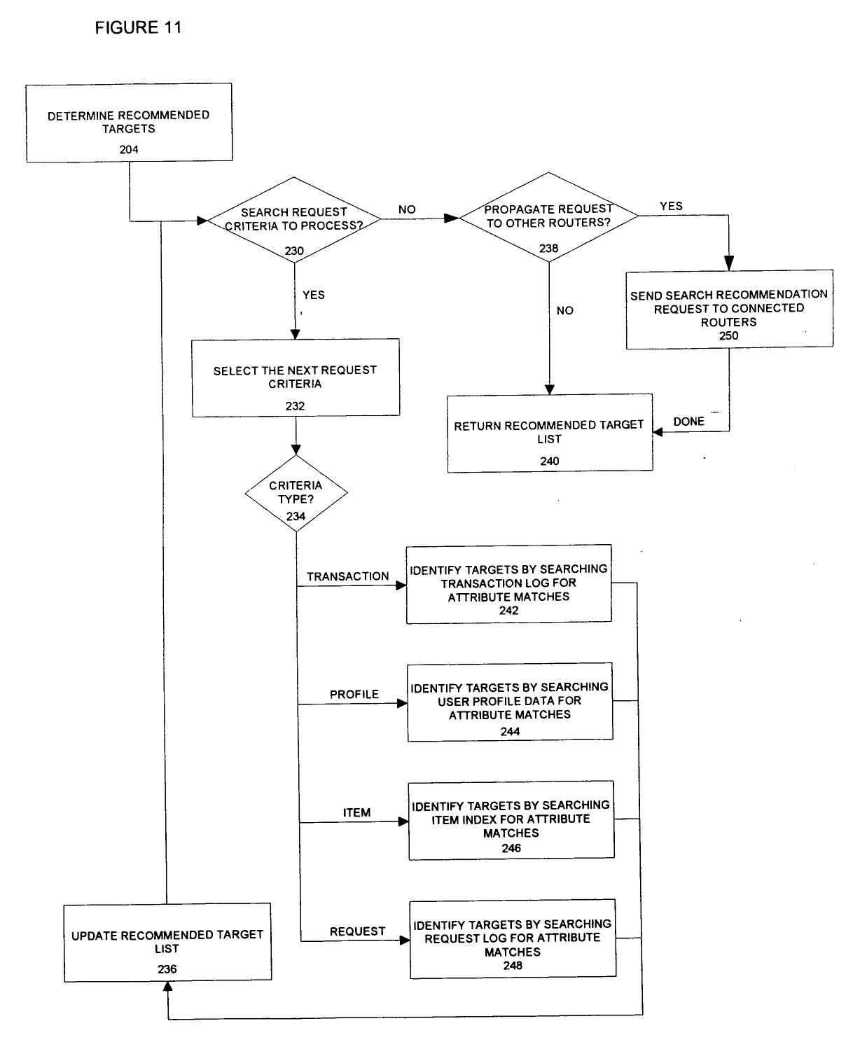

According to one embodiment of the present invention, a goal of a router package is to provide a requesting user with a user list that is relevant to a user request, thereby facilitating business between the requesting user and other users connected to the system. FIG. 11 is a flow diagram showing a method for recommending target users and informing a requesting user of target users' associated item data. This method may be implemented within the recommendation engine 36.

The method processes a list of search criteria that has been supplied by a user from a user package, and user-defined targeting information that describes the scope of the recommendation request. This is performed using a looping technique in steps 230, 232, 234, and 236. First, the process determines if there are still search request criteria to process in block 230. If so, the next request criterion is selected from the list for further processing in block 232. The criteria type is then examined and further processed in the corresponding module described below in blocks 242, 244, 246, and 248.

Each criterion (or condition) provided is processed to determine recommended targets meeting the criterion. After each criterion has been processed, the recommended target list is updated in step 236. Expressions or constraints that combine all the requested criteria with assigned weightings are processed by the update recommended target list process in step 236 to arrive at a composite ranked recommendation list.

According to one embodiment of the present invention, criteria are classified into four categories: transaction criteria, profile criteria, item criteria, and request criteria.

Transaction criteria are processed in step 242. They define conditions that relate to historical transaction information. This can include any data associated with a transaction. One example of historical transaction information is a recording of a transaction between a service provider and a service consumer. The transaction record could include a description of the service provided, the date/time, cost, delivery, and the service consumer's transaction satisfaction rating (i.e. how pleased the consumer was with the service). So, for example, criteria could be defined that enables searches for users who have performed a particular transaction type with at least one consumer satisfaction rating of GOOD.

Profile criteria are processed in step 244. They define conditions that relate to a user's profile information. This profile information includes any user-related data a user package has made public. Examples of user-related data include a user's location, phone number, email address, instant messaging address, and dynamic presence information. An example of these criteria is a specification that requests users that are on-line in Baltimore.

Item criteria are processed in step 246. They define conditions that relate to item data. This includes any item related data that a user package has made public. In the case of items that are goods, examples of public item data include part numbers, quantity available, price, and delivery terms. In the case of items that are services, examples include a service description, hourly rates, knowledge area, or other expertise. An example that applies item criteria would be a specification requesting users who offer commercial plumbing services at a rate less than $100/hr, or a specification requesting users who are experts in nuclear accidents.

Request criteria are processed in step 248. They define conditions that relate to historical request data. This includes all public information associated with a request. Request data could include, for example, the time of the request, the request results, and a correlation between a request and an associated transaction. An example of an application of this type of criterion is an automotive repair shop that wishes to identify potential customers for this service by requesting recommended users who have previously requested a recommendation for automotive repair shops.

Once all criteria have been processed and a final recommended target list has been created, a router package proceeds from step 230 to step 238, where it examines user package-provided target information to determine the scope of the request. If a user package has requested the scope go beyond the attached router package, the search request is forwarded to router packages that are listed in the routing table 42. This decision is made in step 238, and if affirmative, step 250 sends the request to connected routers identified in the routing table 42.

Finally, the recommended target list is returned to the requesting user package in step 240.

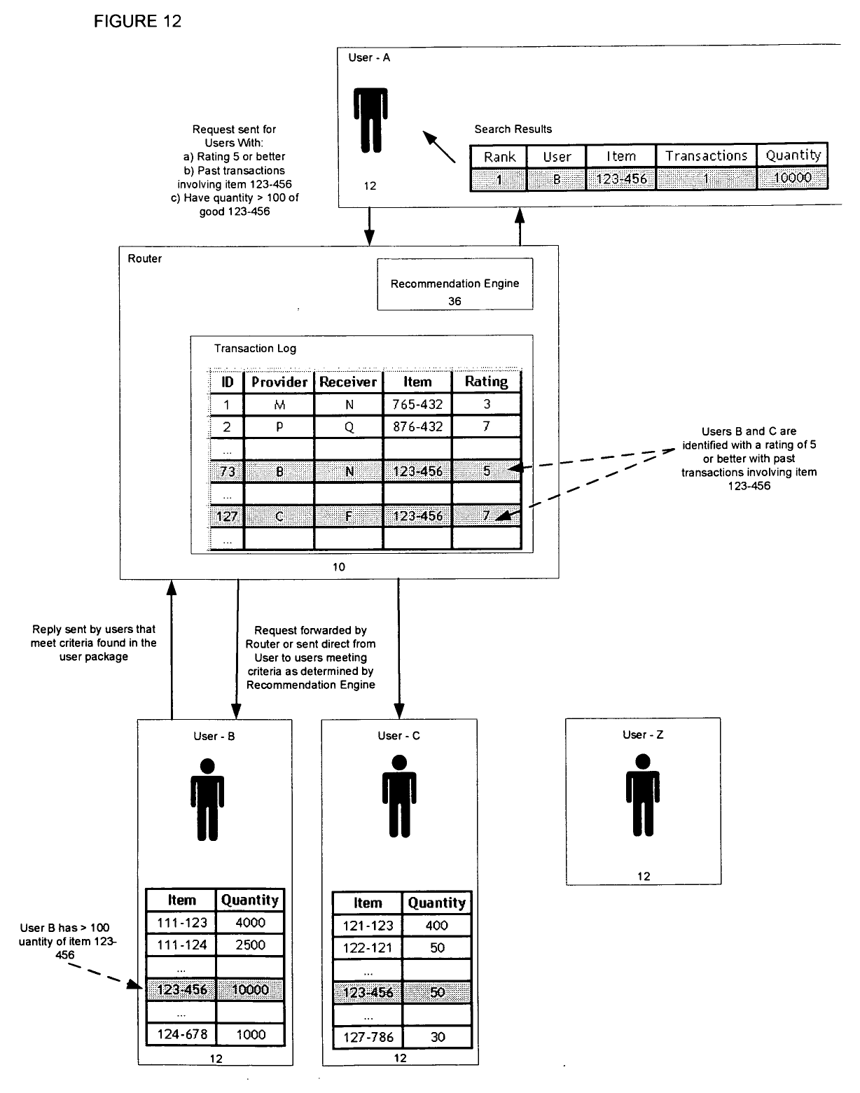

FIG. 12—Use Case # 1—Inventory Visibility, Locating and Trading

FIG. 12 illustrates an embodiment of the invention applied to inventory visibility and enabling the location of users who control that inventory for inventory trading purposes. In this example, user A is requesting a recommendation of other users who: a) have transaction satisfaction ratings of 5 or better; b) have performed past transactions that involve a specific part the user is interested in, part 123-456; and c) have more than one hundred of these specific parts available to be traded.

The user formats a request for recommended users using a user interface on his desktop computer and sends a forward-type request to the local router package. The local router package identifies the criteria the user has requested. Specifically, criteria a) and b) both relate to transaction information, while criteria c) relates to item information. In this example, the local router package has no item information on hand but does have a transaction log that it will analyze.

The local router package analyzes the transaction log and determines that users B and C have performed transactions involving part 123-456, and they both have user satisfaction ratings of at least 5. Since the original request type is of forward-type, the local router package forwards a search request to users B and C for further recommendations.

Users B and C receive the search request with the criteria for available inventory of part 123-456 of more than 100. User B has an inventory of 10,000 units of part 123-456, while user C has only 50 units of part 123-456. User package C sends back a negative response message. User package B sends back an affirmative response message identifying the public data associated with this item. The reply is sent to the originating user package where a ranked list is displayed of users meeting the specified criteria. In this case, only one user is found in the list. At this point the requesting user can decide to perform further actions with User B such as contacting and collaborating with User B.

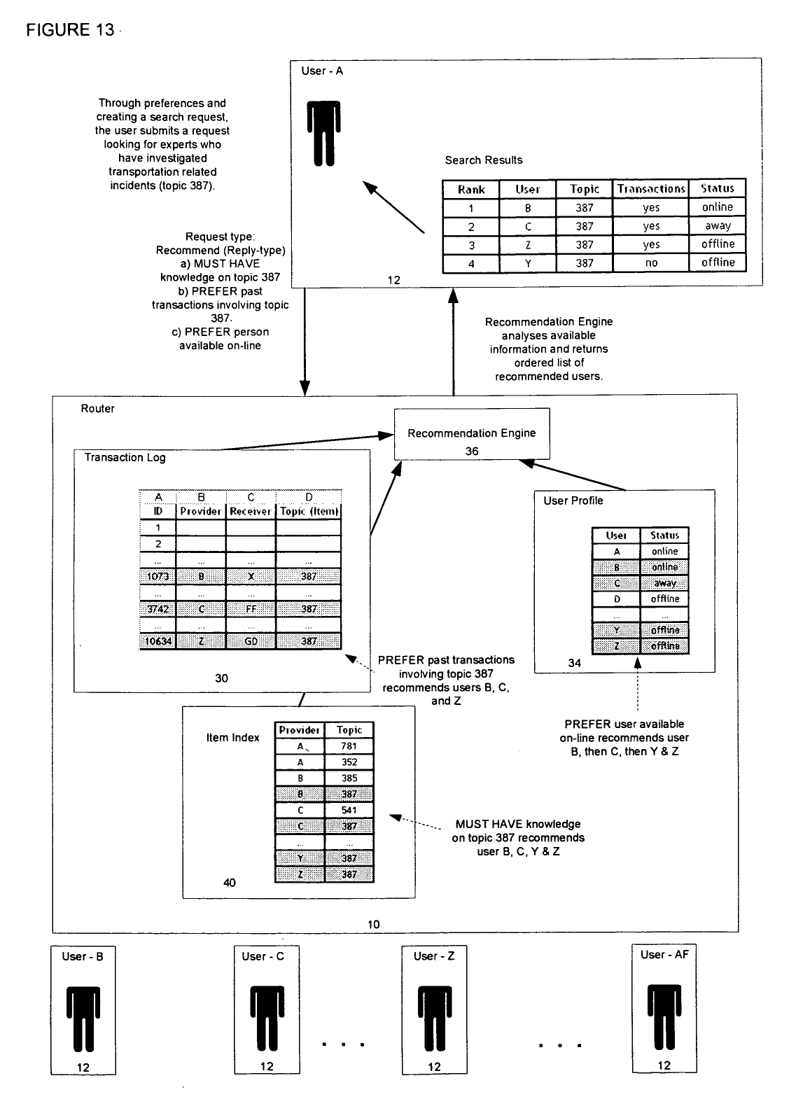

FIG. 13—Use Case #2—Expertise Visibility And Locating—Scenario A

FIG. 13 illustrates an embodiment of the invention applied to expertise visibility and locating users with certain knowledge and capability. This example could be applied to assist a user in locating and recommending any service provider that provides any particular service. In this example, user A is requesting a recommendation of other users who: a) have knowledge or expertise in transportation-related incidents (this is classified in this example system as topic #387), b) have performed past transactions involving the exchange of their expertise in transportation-related incidents, and c) have presence and availability status of “on-line”. These criteria are each qualified with a discrete weighting. In this case two types of weightings are used: MUST HAVE and PREFER. In this example, weightings of MUST HAVE are exclusive, that is the system will only include users in the recommended targets who meet this criteria. In this example, PREFER is not exclusive; it is a rank order factor that indicates that users who meet PREFER criteria should be ranked higher than those who do not.

After the user has input the recommendation request criteria and submitted this request through selecting a button or by other means, the local user package formats a reply-type request with these three criteria and sends this information to the local router package. The local router package receives the recommendation request and analyzes each of the request criteria to determine its recommendations. In this case, there are three different criteria types in the message, respectively: a) an item type criterion, b) a transaction type criterion, and c) a profile type criterion.

The local router package in this example has information pertaining to each of these types of criteria locally available. The recommendation engine 36 processes each of the criteria and compares these to their respective data and determines that users B, C, Z, and Y meet the criteria, to varying degrees. Recommendations are formatted and ranked based on the criteria and an ordered list of recommended users with these items is returned to the requesting user package. Since this is not a forward-type message, a request for further information directly from the recommended users is not sent.

The requesting user package then receives a reply from the local router package in response to the recommendation request. The requesting user package displays the results to the user in ranked order. At this point the requesting user can decide to perform further actions with any of the recommended users such as contacting and collaborating with a recommended user.

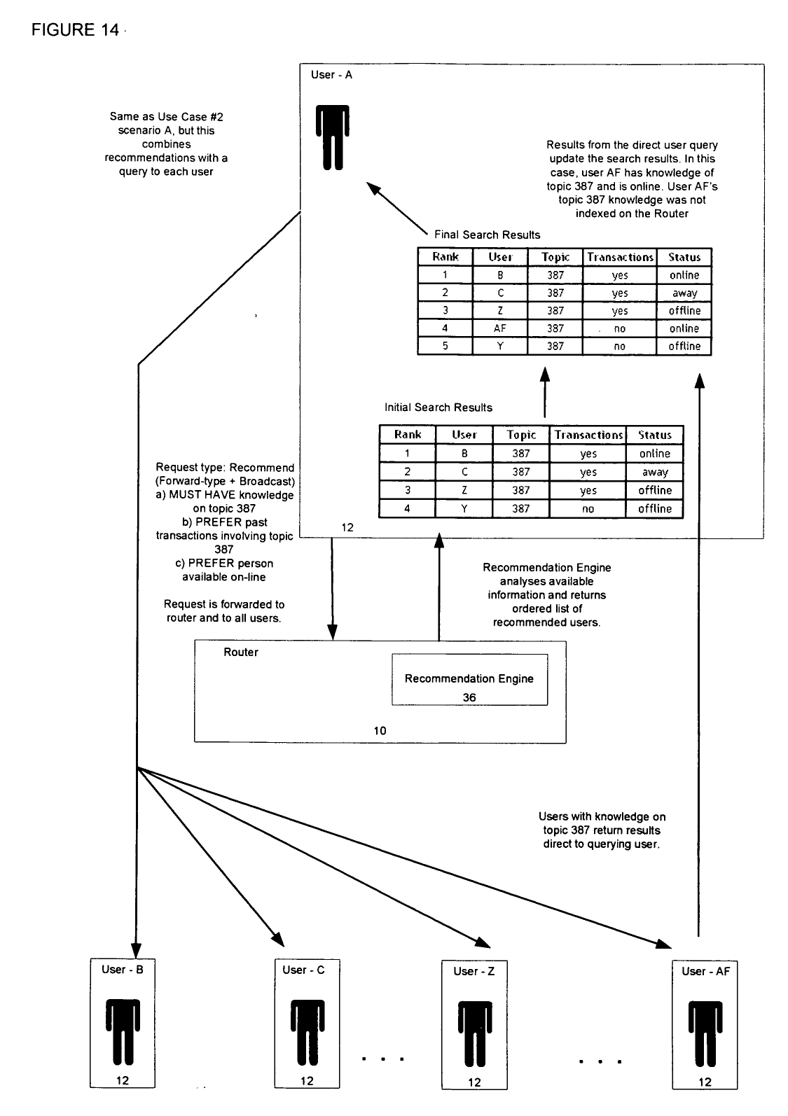

FIG. 14—Use Case #2—Expertise Visibility And Locating—Scenario B

FIG. 14 illustrates an additional scenario applied to the example illustrated in FIG. 13. In this example, user A is requesting exactly the same information with the same criteria described in FIG. 13. The only difference is that the request type made is of forward-type and the user is also broadcasting the request to all users.

After appropriate user inputs, the user package formats a forward-type request with the three criteria and sends this information to the local router package and broadcasts the request to all user packages. As in the previous scenario, the local router package receives the recommendation request and analyzes each of the request criteria to determine its recommendations. The local router package replies to the requesting user package with its recommendations and also forwards the request to recommended user packages.

Upon receipt of the recommendations from the router package, user package A displays the initial search results to the user in ranked order. This ranked list is the same as the list described in the previous scenario.

In response to its broadcast message and the forward-type requests, the user package being used by user A receives responses from all user packages that meet the specified criteria. In this example, messages are received from users B, C, Z, and Y, as is to be expected. In addition, the search has discovered another user, AF, which meets the search criteria. The local router package had no appropriate information on this user. In this case, the reason is that the item index on the router did not contain user AF information. User AF responds with its information and user package A reorders its ranking order based on the new information provided by user AF. Further, a router package may update its information on user AF to ensure that user AF will be properly included as a recommendation for future reply-type requests.

While the present invention has been described with reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

What is claimed is:

1. A method for performing searching across a computer network of users and ranking users based on user associations with items, user data, and user-defined criteria, comprising:
accepting a search request at a first user package;
sending said search request to a router package;
distributing said search request from said router package to other user packages;
comparing said search request to user information at said other user packages;
sending appropriate search responses from said other user packages to said router package;
compiling said search response at said router package into a list of matches; and
sending said list of matches from said router package to said first user package.

2. The method of claim 1 wherein comparing said search request to user information at said other user packages comprises analyzing user associations with items including items under the user's management, supervision or control such as parts, goods for sale, knowledge or services.

3. The method of claim 2 wherein items have associated group association, price, quantity, availability, delivery time, terms, and user-definable attributes defined at said other user packages.

4. The method of claim 1 wherein said user packages contain user information selected from the list consisting of transaction history, satisfaction ratings, user presence, contact information, preferences, security keys, ignore list, manual overrides, network settings, and user account information.

5. The method of claim 1 wherein said first user package ranks said list of matches according to user-defined criteria, said user-defined criteria being a group of attribute settings with user-assigned weightings associated with the user, said attribute settings being provided to and used by a search algorithm that discovers and presents an ordered or ranked list of recommended users with associated items.

6. The method of claim 1 wherein said method is performed using the XML language to describe transactions and other information using a computer network.

7. The method of claim 1 wherein said list of matches is grouped by said first user package according to user-defined criteria.

8. A method of presenting an ordered or ranked list of network participants to a user, based upon network participants' associations with items, user data, and user defined criteria comprising:
accepting at a first user package a search request, said search request comprising data related to a good or a service desired by a searching user;
sending said search request from said first user package to a router package;
sending said search request from said router packages to a plurality of other user packages;
comparing said search request at said other user packages to user data and/or item data at said other user packages; and
sending a positive search response from selected ones of said other user packages to said first user package, said selected ones of said other user packages being selected on the basis of matches between said data related to a good or a service desired by said searching user and said user data or item data at said other user packages.

9. The method of claim 8 wherein user data or item data at said other user packages comprises information regarding items under the management, supervision, and control.

10. The method of claim 8 wherein items have an associated group association, price, quantity, availability, delivery time, terms, and user-definable attributes.

11. The method of claim 8 wherein user data at said other user packages includes transaction history, satisfaction ratings, user presence, contact information, preferences, security keys, ignore list, manual overrides, network settings, and user account information.

12. The method of claim 8 further comprising ordering said positive search responses at said first user package using user-defined criteria, said user-defined criteria comprising a group of attribute settings with user-assigned weightings associated with the user and an item search, said attribute settings being provided to and used by a search algorithm that discovers and presents an ordered list of recommended users with associated items.

13. The method of claim 8 wherein the language used to describe transaction and other information using a computer network is XML.

14. The method of claim 8 further comprising grouping said positive search responses upon their receipt at said first user package.

15. The method of claim 8 wherein an ordered list of network participants at said router package is automatically updated in real-time as the state of items or user defined criteria change.

16. The method of claim 8 wherein a user of said first user package may override elements of the presented list order.

17. The method of claim 8 wherein a user of said first user package may limit the list size to a specific number of items.

18. A method of facilitating interactions among users of a network comprising:
accepting at a user package a search recommendation request from a requesting user, the search recommendation request containing user-defined criteria defining a search item;
forwarding the search recommendation request to a router package;
accepting said search recommendation request at said router package;
comparing said criteria of said search recommendation request to a target list, said target list containing target user profile data comprising information on items controlled by potential target users;
selecting from said target list target users controlling items defined in said user-defined criteria, having said items available, and conforming to said user-defined criteria;
compiling a recommended target list comprising said target users;
delivering said recommended target list to said user package; and
ordering and formatting said recommended target list according to user profile data in said user package.

19. The method of claim 18 wherein said user profile data in said user package comprises public user profile data and private user profile data, said public user profile data being accessible by said router package for preparing said target list.

20. The method of claim 18 wherein selecting said target users from said target list comprises ranking said target users according to historical transaction information.
